(19) United States
(12) Patent Application Publication
(10) Pub. No.: US 2015/0081492 A1
(43) Pub. Date: Mar. 19, 2015

(54) TRANSACTIONAL RISK DAILY LIMIT UPDATE ALARM

(71) Applicant: International Business Machines Corporation, Armonk, NY (US)

(72) Inventors: JoAnn P. Brereton, Hawthorne, NY (US); Arun Hampapur, Norwalk, CT (US); Hongfei Li, Briarcliff Manor, NY (US); Robin Lougee, Yorktown Heights, NY (US); Buyue Qian, Ossining, NY (US)

(73) Assignee: INTERNATIONAL BUSINESS MACHINES CORPORATION, Armonk, NY (US)

(21) Appl. No.: 14/027,428

(22) Filed: Sep. 16, 2013

(51) Int. Cl. G06Q 40/02

(52) U.S. Cl. CPC G06Q 40/02
USPC 705/35

(57) ABSTRACT

Embodiments relate to a transactional risk daily limit (TRDL) update alarm. Customer data including historical transaction data and customer profile data is accessed, along with economic data from an external data source. A TRDL alarm analytics model is applied to the customer data and the economic data to predict a number of transactions in a specified time period that are expected to exceed a TRDL. The TRDL alarm analytics model takes into account a payment transaction pattern associated with the customer. A threshold value is compared to the number of transactions in the specified time period that are expected to exceed the TRDL. An increase in the TRDL is requested to be applied at least during the specified time period based on the number of transactions in the specified time period that are expected to exceed the TRDL being greater than the threshold value.

### BACKGROUND

The present invention relates generally to bank management systems and, more specifically, to a transactional risk daily limit (TRDL) update alarm.

Banks often do not have a clear view of available funds in corporate client accounts. This lack of visibility is due to distributed operations, computer systems that operate independently of each other, and system latency. In order to support the processing of large payment requests, banks often provide a TRDL service. When a TRDL service is used, payment requests are processed without human intervention as long as the daily accumulation of payments flowing into an account and payments flowing out of the account is below a dollar limit (e.g., a TRDL) specified for the account. If the daily accumulation of payments flowing into the account and payments flowing out of the account is above the TRDL, the payment of the payment request is suspended pending approval from a manager at the bank such as an account manager or risk manager.

TRDLs are typically instituted by banks for only a segment of corporate customers due to the processing costs involved in assessing and reassessing a TRDL for each customer. TRDLs are assessed and set for new customers, and then periodically reassessed for current customers. A TRDL is generally reassessed for existing customers as part of a yearly review and/or when the finances of an existing customer have had a significant change. The processing costs of TRDL assessment stem, in part, from the manual effort required to evaluate customer profile and other relevant data. When a transaction that will exceed a TRDL is requested for a customer, an exception condition occurs and the transaction is suspended until a decision to approve or reject the transaction is completed. Currently, this decision process is performed using a labor intensive manual evaluation process that includes having a bank employee assessing the impact of the exception by reviewing customer profile information and other financial data related to the customer. This suspension of the payment process can have a negative impact on customer relationships when it happens on a frequent basis.

### SUMMARY

According to one embodiment of the present invention, a method for providing a transactional risk daily limit (TRDL) update alarm. The method includes accessing, by a processor, customer data including historical transaction data and customer profile data associated with a customer. Economic data from an external data source is accessed via a network. A TRDL alarm analytics model is applied, by the processor, to the customer data and the economic data to predict a number of transactions in a specified time period that are expected to exceed a TRDL associated with the customer. The TRDL alarm analytics model takes into account a payment transaction pattern associated with the customer. A threshold value is compared to the number of transactions in the specified time period that are expected to exceed the TRDL associated with the customer. An increase in the TRDL is requested to be applied at least during the specified time period based on the number of transactions in the specified time period that are expected to exceed the TRDL associated with the customer being greater than the threshold value.

According to another embodiment of the present invention, a system for providing a TRDL update alarm. The system includes a processor communicatively coupled to a network. A TRDL processing tool is executable by the processor. The TRDL processing tool is configured to implement a method that includes accessing customer data including historical transaction data and customer profile data associated with a customer. Economic data from an external data source is accessed via the network. A TRDL alarm analytics model is applied to the customer data and the economic data to predict a number of transactions in a specified time period that are expected to exceed a TRDL associated with the customer. The TRDL alarm analytics model takes into account a payment transaction pattern associated with the customer. A threshold value is compared to the number of transactions in the specified time period that are expected to exceed the TRDL associated with the customer. An increase in the TRDL is requested to be applied at least during the specified time period based on the number of transactions in the specified time period that are expected to exceed the TRDL associated with the customer being greater than the threshold value.

According to a further embodiment of the present invention, a computer program product for providing a TRDL update alarm. The computer program product includes a storage medium embodied with machine-readable program instructions, which when executed by a computer causes the computer to implement a method. The method includes accessing customer data including historical transaction data and customer profile data associated with a customer. Economic data from an external data source is accessed via the network. A TRDL alarm analytics model is applied to the customer data and the economic data to predict a number of transactions in a specified time period that are expected to exceed a TRDL associated with the customer. The TRDL alarm analytics model takes into account a payment transaction pattern associated with the customer. A threshold value is compared to the number of transactions in the specified time period that are expected to exceed the TRDL associated with the customer. An increase in the TRDL is requested to be applied at least during the specified time period based on the number of transactions in the specified time period that are expected to exceed the TRDL associated with the customer being greater than the threshold value.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a high-level data flow diagram for transaction risk daily limit (TRDL) processing according to an embodiment of the present invention;

FIG. 2 depicts a process for TRDL assessment according to an embodiment;

FIG. 3 depicts a process for TRDL exception assessment according to an embodiment;

FIG. 4 depicts a process for a generating a TRDL update alarm according to an embodiment; and

FIG. 5 depicts a computer system for TRDL processing according to an embodiment.

### DETAILED DESCRIPTION

Exemplary embodiments provide automated transactional risk daily limit (TRDL) assessment that is driven by an analysis of customer profiles, customer historical transaction patterns, and real-time external market information. Embodiments may also provide automated TRDL exception assessment that is driven by an analysis of customer profiles, customer historical transaction patterns, customer historical exception records, and real-time external market information. When a TRDL exception is detected, an online processing engine generates an approval recommendation (e.g., approve or reject), along with a confidence level associated with the approval recommendation (e.g., on a scale of one to ten), and an approval amount (e.g., a dollar amount). Embodiments described herein may also provide an alarm triggered to initiate an update to a customer's TRDL prior to a TRDL exception occurring. The initiating of the alarm may be performed when an analysis of customer historical transaction patterns, customer profiles, and real-time external market information leads to a prediction that the TRDL is likely to be exceeded by the customer in the near future. Based on the prediction, an update to the TRDL is recommended to prevent the predicted TRDL exception from occurring. The update to the TRDL can remain in effect until the next TRDL update or for specified time periods (e.g., the update is seasonal).

Historical transaction data can be analyzed offline by learning engines to search for patterns and to develop model parameters. These model parameters can then be input to analytic models in conjunction with external data such as real-time market data to perform the TRDL processing described herein. As used herein, the term “analytics driven” refers to a decision engine (or model) that is developed based on analytics using historical data in addition to expert knowledge.

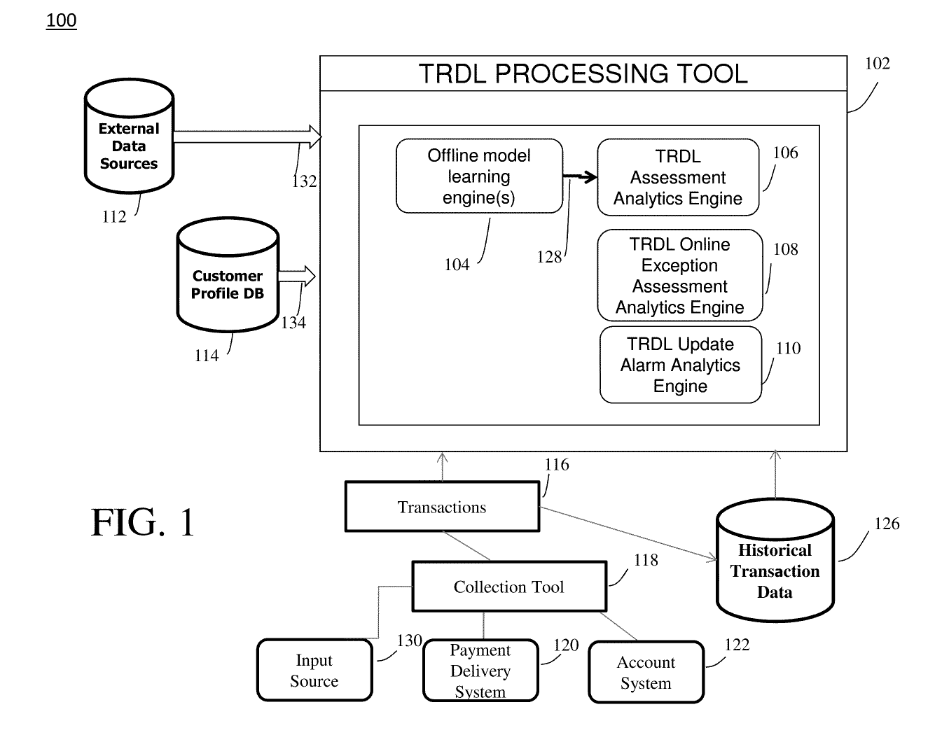

Referring now to FIG. 1, a high-level data flow diagram 100 for TRDL processing in accordance with an embodiment is generally shown. A TRDL processing tool 102 includes one or more offline model learning engines 104 that can access historical data values associated with transactions 116 including, for example, transaction data from one or more transaction input sources 130, payment delivery systems 120, and account systems 122. The payment delivery systems 120 can include systems used for different payment types such as an automated clearing house (ACH) system and a wire system. The account systems 122 can provide customer account information, such as customer name and the TRDL associated with the account.

One or more collection tools 118 can interface to a number of protocols to receive transaction data from the transaction input sources 130, the payment delivery system 120 and the account system 122. For example, the transaction input sources 130 can communicate the transaction data to the collection tool 118 via protocols such as Simple Mail Transfer Protocol (SMTP), Electronic Data Interchange-Internet Integration (EDIINT), File Transfer Protocol (FTP), Hypertext Transfer Protocol (HTTP), Secure File Transfer Protocol (SFTP), Simple Object Access Protocol (SOAP), Web Distributed Authoring and Versioning (WebDAV), Electronic Data Interchange (EDI)/eXtensible Markup Language (XML), and various file systems.

The transaction input sources 130 can include a variety of inputs from electronic access points, bank branches, or other elements of a regional banking network, such as requests from a department computer system or regional banking computer system as compartmentalized entities. For example, the transaction input sources 130 can include, but are not limited to: e-mail, phone/interactive voice response, bank branches, internet cash management software, and bulk files/Enterprise Resource Planning (ERP) to provide the transaction data for the transactions 116. The collection tool 118 provides a common format for the transaction data to be processed from the transaction input sources 130 using any of the supported protocols.

The collection tool 118 can also provide a common format for retrieving data from the payment delivery system 120 and the account system 122. These systems may be implemented as two or more compartmentalized entities, also referred to as “silos”, which can be effectively isolated from each other and observed without direct modification. The data from the silos may be linked (e.g., by the collection tool 118) based on an account or customer number to provide integrated information to the TRDL processing tool 102. In exemplary embodiments, the collection tool 118, which may communicate with one or more networks, provides a generic communication interface between elements that may otherwise be isolated from each other. For example, instances of a department computer system can be separate compartmentalized entities or silos, where a trust department may not have direct access to data in a treasury department even within the same regional banking network.

The historical values of data associated with the transactions 116 are shown in FIG. 1 as historical transaction data 126, which may be used by the offline model learning engines 104 for identifying patterns to produce model parameters 128. Transaction history includes historical information about the transactions conducted between the customer and the bank and/or other enterprises. For example, transaction history data may include frequency of transactions, a frequency and dates of transactions involving a customer's daily limits (cash or credit), exception data, any defaults that may have occurred and the dates of the defaults, and average dollar amount of transactions over a period of time. Transactions may also include investment activity and loan activity. The transactions may relate to financial accounts associated with checking, savings, money market, CDs, mortgages, asset acquisition and sale, etc., and may include deposits, withdrawals, credit purchases, cash purchases, loans, and investments.

The model parameters 128 generated by the offline model learning engine 104 may be formatted as coefficients to be applied by one or more of a TRDL assessment analytics engine 106, an online TRDL exception assessment analytics engine 108, and a TRDL update alarm analytics engine 110. Pattern analysis can include looking for repeating sequences of the transactions 116 in the historical transaction data 126 or other transaction related data based on a particular customer or account. The patterns may also include tracking time between posting and completion of repeated transactions 116 based on a particular transaction input source, customer, account, and/or payment delivery system 120. Failed transactions 116, for instance, due to insufficient funds, may also be tracked on a customer and/or account basis to determine a risk factor or likelihood of repetition of a similar pattern. The one or more offline model learning engines 104 may operate on historical transaction data 126 spanning several years to improve a level of confidence associated with identified patterns used to create the model parameters 128. The one or more offline model learning engines 104 may also access external information 132 from the external data sources 112 in developing patterns for the model parameters 128. For example, accessing a customer credit report can increase confidence in a likelihood of repetition of successful or failed transactions 116.

Embodiments of the TRDL assessment analytics engine 106, online TRDL exception assessment analytics engine 108, and TRDL update alarm analytics engine 110 can use, as input, the model parameters 128 in combination with customer profile data 134 from the customer profile database 114, transactions 116, and external information 132 from external data sources 112.

Customer profile data 134 may include information derived from customer accounts stored and managed by banking systems such as the account system 122. For example, customer profile data 134 may include customer type (e.g., business, personal consumer, for-profit, non-profit, charitable, etc.), customer geographic location(s), number of employees, annual revenue, industry of customer business (e.g., manufacturing, retail, health care, insurance, etc.), length of employment, assets owned, and customer age. The customer profile data 134 may be used to define characteristics as a foundation to group customers that share similar traits. For example, one characteristic may be the size of the customer in terms of the number of employees and/or the annual revenue generated by the customer. Another characteristic may be type of business the customer is engaged in.

In an embodiment, the external information 132 includes economic data such as historical and/or real-time market data related to the economic health of the particular customer, the economic health of the region in which the customer operates, the economic health of the industry in which the customer operates, and/or the current health of the national or global market as a whole. Economic health data may be obtained for a particular customer in part, e.g., from an annual financial report published by the customer or credit scores obtained from a credit report. Economic health information about a region, industry, etc. of the market may be obtained, e.g., from the stock market, current interest rates, industry news reports, etc. The economic health of a particular customer, region of the customer, and industry of the customer may be used, similar to the customer profile data, to group customers that share similar economic health traits. The health of the market as a whole can also be used in implementing the production recommendation processes described herein. For example, in a healthy market, additional services (or services having more customer-favored terms) may be offered to more of the customers of the enterprise, as compared to what may be offered in a lean market.

For example, accessing Bloomberg reports as the external information 132 for a business account can provide further insight as to the likelihood of the transactions 116 following previous patterns or an increased risk of failing to repeat previous patterns, e.g., based on a recent negative report associated with customer profile data 134 for a particular customer involved in a transaction 116.

Though shown in FIG. 1 as four separate engines, the offline model learning engines 104, TRDL assessment analytics engine 106, online TRDL exception assessment analytics engine 108, and TRDL update alarm analytics engine 110 can be implemented as one or more combined engines within the TRDL processing tool 102.

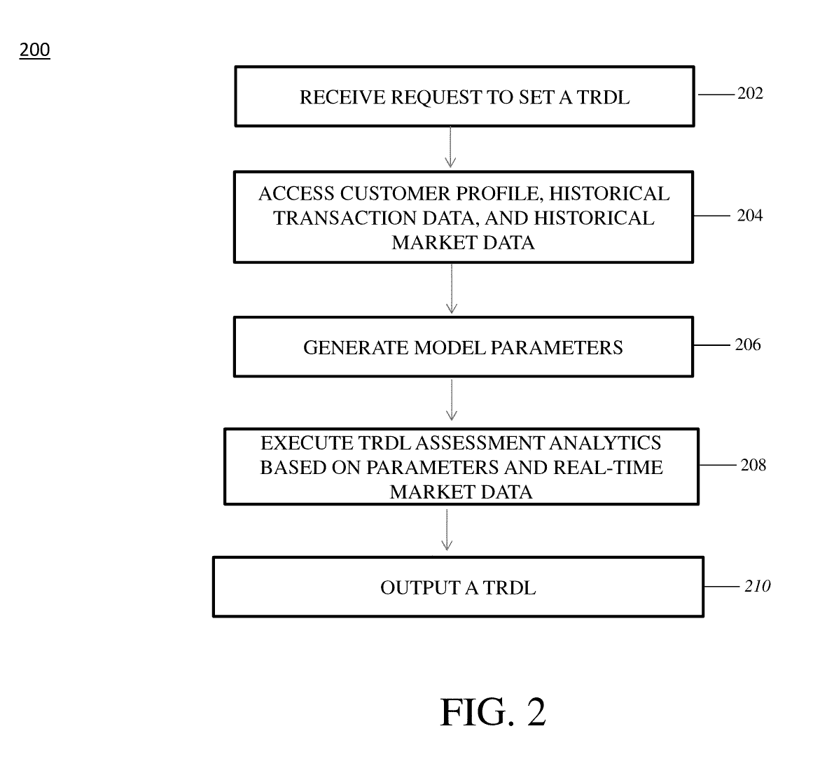

Referring now to FIG. 2, a process 200 for applying a TRDL assessment model to perform TRDL assessment in accordance with an embodiment is generally shown. The process shown in FIG. 2 may be implemented by a combination of the offline model learning engine 104 and the TRDL assessment analytics engine 106 shown in FIG. 1, executing on a computer. At block 202, a request to set a TRDL for a customer is received (e.g., from a bank employee). At block 204, customer profile data 134 associated with the customer is accessed (e.g., from the customer profile database 114), historical transaction data 126 is accessed, and historical market data (e.g., from external data sources 112). In an embodiment, at block 206, the offline model learning engine 104 inputs the customer profile data 134, the historical transaction data 126 and the historical market data and generates model parameters 128. The model parameters 128 may include, but are not limited to: historical maximum daily transaction amount in a year, client credit risk score, stock market status, exception history, and client profile (e.g., company size, industry, revenue, and stock price).

A model is developed by the offline model learning engine 104 using analytics techniques, such as machine learning or statistical modeling. In an embodiment, transactions 116 are labeled as good or bad. A bad transaction is one where the bank took the risk to approve the transaction 116, and the sender (e.g., customer) defaulted and did not pay it off by the end of the day. These labels may be based on default records in the historical transaction data 126 that include information about payment requests that were approved by the bank even though they exceeded a customer's TRDL. The problem to be solved is treated as a classification problem, and a model is developed to classify transactions 116 as good or bad based on feature inputs. Training data sets are generated that contain all of the features that may contribute to the classification and the corresponding labels. Examples of features include, but are not limited to: transaction amount, payment type, sender's credit, and revenue. The model may be trained using historical data, such as the historical transaction data 126. Once the model parameters are learned, the model may be used for transaction classification.

Once the model parameters 128 are estimated (e.g., learned) by the offline model learning engine 104, block 208 is performed. At block 208, the TRDL assessment analytics engine 106 is executed to generate a suggested TRDL using both the model parameters 128 and real-time market information retrieved as external information 132 from the external sources 112 as input. Examples of real-time market information include, but are not limited to industry trending reports that indicate a growing market, a stable or a matured market. A growing market may indicate more active and larger payment transaction activities. In an embodiment, the TRDL assessment analytics engine 106 can be executed in an offline mode and a model is developed using analytics techniques, such as machine learning and/or statistical modeling. When generating the suggested TRDL, the model may take into consideration several factors such as, but not limited to: maximum payment transactions in the last eighteen months, client industry, client revenue, client credit, and transaction amount trending. At block 210, the suggested TRDL is output.

In an embodiment, input to the offline model learning engine 104 may also include historical account data and historical exception data (e.g., payment request amount, approved or not, and default history).

The TRDL assessment analytics engine 106 can determine a suggested TRDL based on integrated information from customer historical transaction behaviors and other factors as described herein. In an embodiment, the model used by the TRDL assessment analytics engine 106 takes into consideration a seasonality pattern (e.g., higher payment requests are typically made in July when compared to February). Seasonality pattern discovery can be performed to determine whether the customer has strong transaction seasonal patterns. If the customer does not exhibit strong transaction seasonal patterns, then a constant TRDL over a year will be recommend. If the customer does exhibit strong transaction seasonal patterns, then a TRDL that varies seasonally (e.g., by month, week in the month, quarter, etc.) may be recommended.

Other factors that may be taken into account by the model used by the TRDL assessment analytics engine 106 include client risk scores (e.g., higher risk and lower credit customers get a lower TRDL), real-time market information (e.g., interest rates, stock market level, economic conditions), and the customer's predicted need for cash in the future (e.g., in one year).

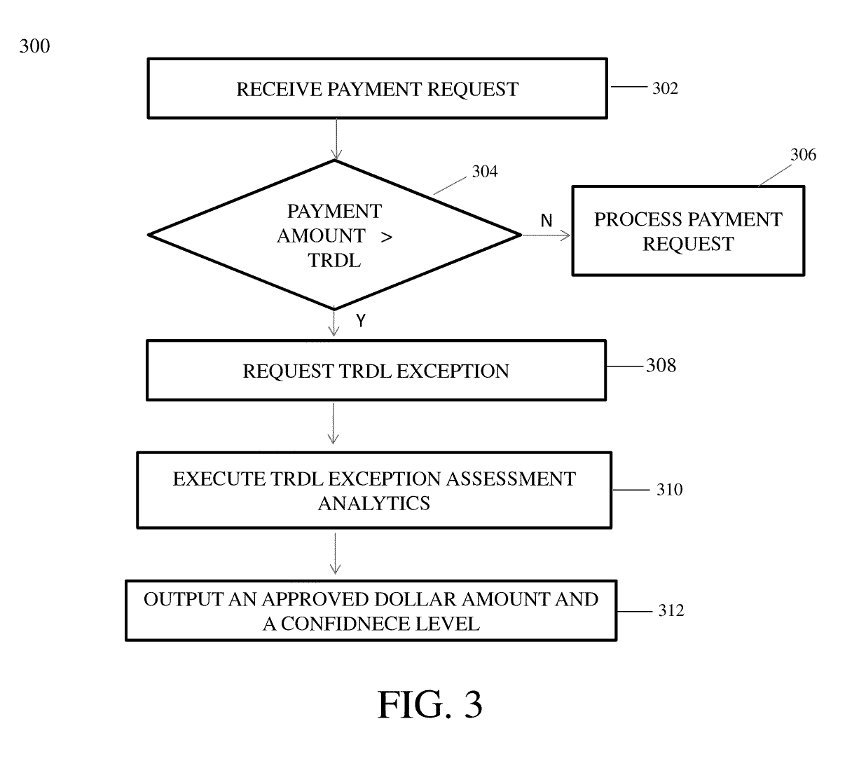

Referring now to FIG. 3, a process 300 for applying a TRDL exception model to perform TRDL exception assessment in accordance with an embodiment is generally shown. The process 300 shown in FIG. 3 may be implemented by a combination of the offline model learning engine 104 and the online TRDL assessment analytics engine 106 shown in FIG. 1, executing on a computer. The offline learning engine 104 may use machine learning, data mining and statistical approaches to analyze customer historical payment patterns as described previously. The online TRDL assessment analytics engine 106 may be used for real-time TRDL exception assessment when an incoming transaction 116 with a payment request exceeds the TRDL.

At block 302, transaction 116 that includes a payment request is received (e.g., by the payment delivery system 120). Processing continues at block 304, where it is determined whether processing the payment request would cause the TRDL to be exceeded for the customer (or account). Block 306 is performed to process the payment request if it is determined that processing the payment request would not cause the TRDL to be exceeded. Block 308 is performed to request a TRDL exception if it is determined, at block 304, that processing the payment request would cause the TRDL to be exceeded.

Processing continues at block 310, where TRDL exception assessment analytics are performed. Inputs to a model used by the analytics may include, but are not limited to: customer historical transaction data, historical account data, historical exception data, historical real-time market data, and a customer profile data 134 (such as industry, company size, revenue, CEO, etc.). As described previously, for each new payment request where the payment accumulation exceeds the TRDL, the alert triggers running the model. The analytics engine generates an approval recommendation (approved or rejected) with a confidence a level (e.g., a percentage or on a scale from 1 to 10) and an approval amount when approval is recommended. At block 312, the recommendation, confidence level and approval amount are output.

Embodiments of the TRDL exception assessment processing integrate information from customer historical transaction behaviors and other factors as listed above. Embodiments may take into consider several factors when assessing a TRDL exception for a customer such as, but not limited to: payment transaction patterns which may justify the large payment amount request if it falls into the pattern; customer risk scores (e.g., higher risk and lower credit clients more likely get rejected); transaction attributes, such as amount, receiver, payment type, etc; real-time market information (e.g., interest rate, stock market, economic condition may also affect exception assessment); and customer relationship. An embodiment of the TRDL online exception assessment analytics engine 108 models the probability of client default for this transaction as a function of one or more of these factors which may be input as model parameters 128.

An embodiment of the TRDL online exception assessment analytics engine 108 uses logistic regression to model the probability as: log(p/(1−p))=a_{—}1*X_{—}1+a_{—}2*X_{—}2+ . . . +a_p*X_p. In this equation, p is the probability of customer default and X_{—}1, X_{—}2, . . . , X_p are the contributing factors. a_{—}1, a_{—}2, . . . , a_p are the parameters to estimate the impact of the contributing factors. When p is high, customer default risk for this transaction may be high, and a recommendation of “not approval” may be likely. Other classification problems or other approaches may also be implemented by embodiments.

The confidence level of the recommendation may be calculated as (1−p). The approval amount may be positively associated with the approval confidence level while considering client certain specific requirements. The model approval amount may be modeled as the multiplication product of the payment request and the approval confidence level (1−p). Other modeling techniques may also be implemented.

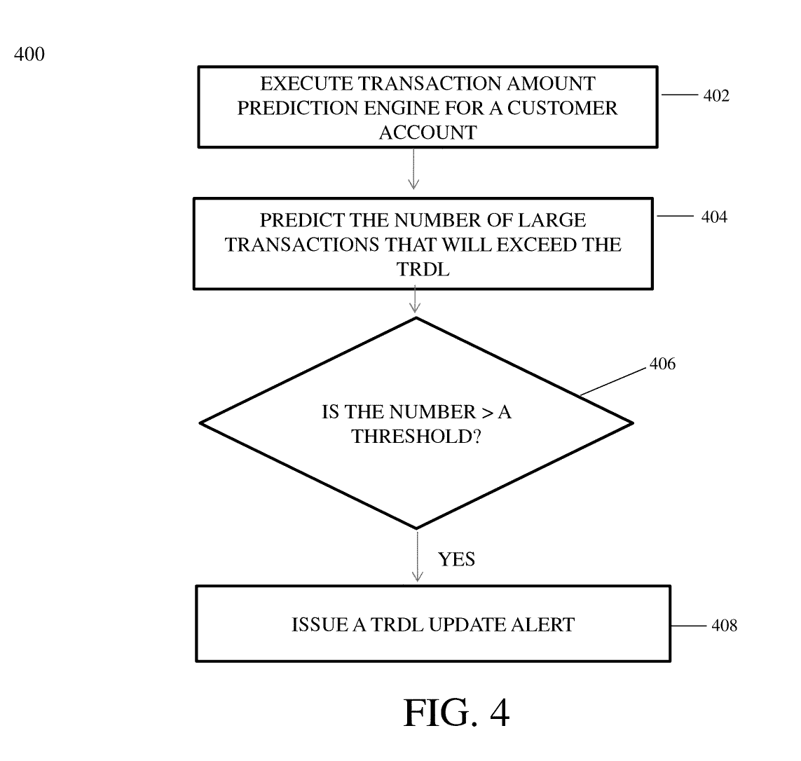

Referring now to FIG. 4, a process 400 for applying a TRDL update alarm model to perform TRDL update alarm generating in accordance with an embodiment is generally shown. The process 400 shown in FIG. 4 may be implemented by a combination of the offline model learning engine 104 and the TRDL update alarm analytics engine 110 shown in FIG. 1, executing on a computer. At block 402, a model is used to predict future transaction amounts. Inputs to the model may include customer historical transaction data, historical account data, historical exception data, historical real-time market data, and customer profiles (such as industry, company size, revenue, CEO, etc.). The model outputs predicted daily transaction amounts from the client over a certain time window, such as one month.

An embodiment of the prediction model takes into account factors such as, but not limited to: payment transaction patterns, such as seasonality patterns; customer profiles (company size, industry, revenue, etc.); and market information (interest rate, stock market, and economic conditions. An embodiment of the prediction model uses a time series model for prediction. Let y_t denote the daily transaction amount at day t, where t=1, . . . , 30. Then y_t can be expressed as:

y_{—}t=a1*y_(t−1)+a2*y_(t−2)+ . . . +ak*y_(t−k)+b1*y_(t−7)+b2*y_(t−30)+c1*x1_{—}t+c2*x2_{—}t+ . . . +cp*xp_{—}t+white noise;

where y_(t−1), y_(t−2), . . . , y_(t−k) are the past k days daily transaction amounts; y_(t−7) is used to capture the weekly pattern; y_(t−30) captures a monthly pattern; x1_t, x2_t, . . . , xp_t are other contributing factors (e.g., company's credit score, revenue, etc.); and a1, a2, . . . are parameters which indicates the factor impacts.

Once the parameters are estimated, y_t can be predicted as future day t's daily transaction amount.

The predicted future transaction amounts are compared to the TRDL, at block 404, to determine a predicted frequency of large transactions that exceed the TRDL in a specified future time window. Customer historical transaction patterns are analyzed along with customer profiles and real-time external information such as market reports.

At block 406, the predicted number of large transactions that exceed the TRDL is compared to a threshold value, or tolerance threshold, for the customer or customer account. Block 408 is performed when the number of large transactions that exceed the TRDL is predicted to exceed the tolerance threshold. At block 408, an update alert is issued. In this manner, an alarm is triggered when a frequent hitting pattern is detected, signaling that the TRDL should be updated to avoid frequent manual exception assessment. In an embodiment, the alarm includes a request for an increase in the TRDL at least during the the specified future time period. The amount of the increase may be based on a monetary value associated with predicted transactions in the specified time period that are expected to exceed the TRDL associated with the customer.

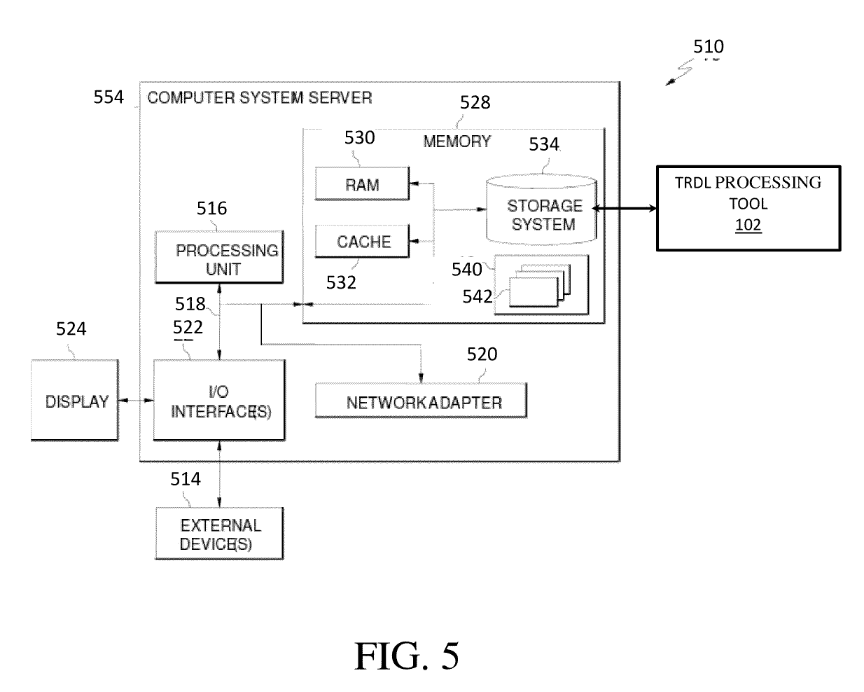

Referring now to FIG. 5, a schematic of an example of a computer system 554 in an environment 510 is shown. The computer system 554 is only one example of a suitable computer system and is not intended to suggest any limitation as to the scope of use or functionality of embodiments described herein. Regardless, computer system 554 is capable of being implemented and/or performing any of the functionality set forth hereinabove.

In the environment 510, the computer system 554 is operational with numerous other general purpose or special purpose computing systems or configurations. Examples of well-known computing systems, environments, and/or configurations that may be suitable as embodiments of the computer system 554 include, but are not limited to, personal computer systems, server computer systems, cellular telephones, thin clients, thick clients, hand-held or laptop devices, multiprocessor systems, microprocessor-based systems, set top boxes, programmable consumer electronics, network personal computer (PCs), minicomputer systems, mainframe computer systems, and distributed cloud computing environments that include any of the above systems or devices, and the like.

Computer system 554 may be described in the general context of computer system-executable instructions, such as program modules, being executed by one or more processors of the computer system 554. Generally, program modules may include routines, programs, objects, components, logic, data structures, and so on that perform particular tasks or implement particular abstract data types. Computer system 554 may be practiced in distributed computing environments, such as cloud computing environments, where tasks are performed by remote processing devices that are linked through a communications network. In a distributed computing environment, program modules may be located in both local and remote computer system storage media including memory storage devices.

As shown in FIG. 5, computer system 554 is shown in the form of a general-purpose computing device. The components of computer system 554 may include, but are not limited to, one or more computer processing circuits (e.g., processors) or processing units 516, a system memory 528, and a bus 518 that couples various system components including system memory 528 to processor 516. The processor 516 may be communicatively coupled to one or more networks and computer systems to perform the processing described herein.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 554 typically includes a variety of computer system readable media. Such media may be any available media that is accessible by computer system 554, and it includes both volatile and non-volatile media, removable and non-removable media.

System memory 528 can include computer system readable media in the form of volatile memory, such as random access memory (RAM) 530 and/or cache memory 532. Computer system 554 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein. An example application program or module is depicted in FIG. 5 as TRDL processing tool 102 of FIG. 1. Although the TRDL processing tool 102 is depicted separately, it can be incorporated in any application or module. The TRDL processing tool 102 can be stored directly in the memory 528 or can be accessible by the processor 516 from a location external to the computer system 554.

Computer system 554 may also communicate with one or more external devices 514 such as a keyboard, a pointing device, a display device 524, etc.; one or more devices that enable a user to interact with computer system 554; and/or any devices (e.g., network card, modem, etc.) that enable computer system 554 to communicate with one or more other computing devices. Such communication can occur via input/output (I/O) interfaces 522. Still yet, computer system 554 can communicate with one or more networks such as a local area network (LAN), a general wide area network (WAN), and/or a public network (e.g., the Internet) via network adapter 520. As depicted, network adapter 520 communicates with the other components of computer system 554 via bus 518. It should be understood that although not shown, other hardware and/or software components could be used in conjunction with computer system 554. Examples, include, but are not limited to: microcode, device drivers, redundant processing units, external disk drive arrays, redundant array of independent disk (RAID) systems, tape drives, and data archival storage systems, etc.

It is understood in advance that although this disclosure includes a detailed description on a particular computing environment, implementation of the teachings recited herein are not limited to the depicted computing environment. Rather, embodiments are capable of being implemented in conjunction with any other type of computing environment now known or later developed (e.g., any client-server model, cloud-computing model, etc.).

Technical effects and benefits include automating TRDL processing which may reduce the time and manual labor required for establishing or updating a TRDL. In addition, by providing access to a variety of data sources, embodiments can provide a more accurate TRDL that is customized based on analytics for each customer. TRDL services may be provided to more customers due to the automation of the processing. Technical effects and benefits also include a reduction in the time and manual labor required for TRDL exception assessment.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A method for providing a transactional risk daily limit (TRDL) update alarm, the method comprising:
accessing, by a processor, customer data including historical transaction data and customer profile data associated with a customer;
accessing economic data from an external data source, the accessing via a network;
applying, by the processor, a TRDL alarm analytics model to the customer data and the economic data to predict a number of transactions in a specified time period that are expected to exceed a TRDL associated with the customer, the TRDL alarm analytics model taking into account a payment transaction pattern associated with the customer;
comparing a threshold value to the number of transactions in the specified time period that are expected to exceed the TRDL associated with the customer; and
requesting an increase in the TRDL to be applied at least during the specified time period based on the number of transactions in the specified time period that are expected to exceed the TRDL associated with the customer being greater than the threshold value.

2. The method of claim 1, wherein an amount of the increase is based on a monetary value associated with predicted transactions in the specified time period that are expected to exceed the TRDL associated with the customer.

3. The method of claim 1, wherein the customer data is sourced from a plurality of compartmentalized entities.

4. The method of claim 1, wherein the TRDL alarm analytics model further takes into account at least one of a seasonality pattern of the customer data, a credit risk score of the customer, a seasonality.

5. The method of claim 1, wherein the TRDL alarm analytics model further takes into account at least one of a seasonality pattern of an industry associated with the customer, and market information associated with the industry associated with the customer.

6. The method of claim 1, wherein the customer data further includes at least one of account data and exception data associated with the customer.

7. The method of claim 1, wherein the TRDL alarm analytics model uses at least one of learning and statistical techniques to predict the number of transactions in the specified time period that are expected to exceed the TRDL associated with the customer.

8. The method of claim 1, wherein the economic data includes real-time market data.

9-14. (canceled)

15. A computer program product for providing a TRDL update alarm, the computer program product comprising a storage medium embodied with machine-readable program instructions, which when executed by a computer, causes the computer to implement a method, the method comprising:
accessing customer data including historical transaction data and customer profile data associated with a customer;
accessing economic data from an external data source, the accessing via a network;
applying a TRDL alarm analytics model to the customer data and the economic data to predict a number of transactions in a specified time period that are expected to exceed a TRDL associated with the customer, the TRDL alarm analytics model taking into account a payment transaction pattern associated with the customer;
comparing a threshold value to the number of transactions in the specified time period that are expected to exceed the TRDL associated with the customer; and
requesting an increase in the TRDL to be applied at least during the specified time period based on the number of transactions in the specified time period that are expected to exceed the TRDL associated with the customer being greater than the threshold value.

16. The computer program product of claim 15, wherein an amount of the increase is based on a monetary value associated with predicted transactions in the specified time period that are expected to exceed the TRDL associated with the customer.

17. The computer program product of claim 15, wherein the customer data is sourced from a plurality of compartmentalized entities.

18. The computer program product of claim 15, wherein the TRDL alarm analytics model further takes into account at least one of a seasonality pattern of the customer data, a credit risk score of the customer, a seasonality.

19. The computer program product of claim 15, wherein the TRDL alarm analytics model further takes into account at least one of a seasonality pattern of an industry associated with the customer, and market information associated with the industry associated with the customer.

20. The computer program product of claim 15, wherein the economic data includes real-time market data.
